(19) United States
(12) Patent Application Publication
(10) Pub. No.: US 2010/0172222 A1
(43) Pub. Date: Jul. 8, 2010

(54) INFORMATION REPRODUCING APPARATUS, SERVO ADJUSTING METHOD, AND THE LIKE

(75) Inventors: Yoshihiro Hashizuka, Saitama (JP); Yoshimichi Nishio, Saitama (JP); Hiroyuki Kobayashi, Saitama (JP); Hiroki Goto, Saitama (JP); Hideaki Tsurumi, Saitama (JP); Takaaki Ujiie, Saitama (JP); Hiroshi Someya, Saitama (JP); Manabu Shimodaira, Saitama (JP); Hidetaka Urabe, Saitama (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation, Meguro-ku, Tokyo (JP)

(21) Appl. No.: 12/160,730

(22) PCT Filed: Jan. 10, 2007
(86) PCT No.: PCT/JP2007/050111

§ 371 Date: Jul. 11, 2008

(30) Foreign Application Priority Data
Jan. 13, 2006 (JP) 2006-005666

(51) Int. Cl. G11B 7/00

(52) U.S. Cl. 369/44.27; G9B/7

(57) ABSTRACT

The present invention provides an information processing apparatus, a servo adjustment method, and the like realizing reduced time required for servo adjustment.

An information reproducing apparatus according to the present invention is for reproducing information recorded on a recording medium having a plurality of recording layers.

The apparatus includes: signal level measuring means for measuring a signal level of each of recording layers; and servo adjusting means for performing servo adjustment on at least one of the recording layers, storing a servo adjustment value in the servo adjustment, and in the case where the recorded information is reproduced from the recording layers, performing servo adjustment on the recording layers so as to become to the servo adjustment value.

When a level ratio of signal levels of at least two recording layers in the measured signal levels of the recording layers lies in a threshold range, the servo adjusting means performs the servo adjustment on one of the recording layers, stores the servo adjustment value in the servo adjustment, and in the case where the recorded information is reproduced from the other recording layer, performs the servo adjustment on the other recording layer so as to become to the servo adjustment value for one recording layer.

### TECHNICAL FIELD

The present invention relates to the technical field of an information reproducing apparatus for reproducing information recorded on a recording medium such as an optical disk having a plurality of recording layers.

### BACKGROUND ART

To reproduce information recorded on an optical disk such as a DVD (Digital Versatile Disc), for example, as disclosed in Patent Document 1, adjustment of offset, gain, balance, and the like of focusing servo and tracking servo (hereinbelow, called “servo adjustment”) has to be performed in advance so that focusing servo for converging a laser light flux of an optical pickup onto a pit surface of the optical disk and tracking servo for moving the optical pickup in the radial direction along a recording track of the optical disk can be performed accurately.

In an optical disk having a plurality of recording layers (so-called multilayer-structured optical disk), a servo adjustment value basically varies among the layers. Consequently, each time a recording layer to be reproduced is switched, readjustment of the servo has to be performed. There is a problem such that a recording layer to be reproduced cannot be switched smoothly.

To address the problem, in the technique disclosed in the patent document 1, servo adjustment is performed for predetermined time in each of the recording layers of an optical disk. A servo adjustment value in the servo adjustment is stored for each of the recording layers. At the time of reproducing the optical disk, the servo adjustment value corresponding to the recording layer to be reproduced is read, and the servo adjustment is performed with the read servo adjustment value. As a result, it is unnecessary to execute adjustment each time the recording layer to be reproduced is switched, so that the time required to switch a recording layer to be reproduced can be shortened.

Patent Document 1: Japanese Patent Application Laid-Open (JP-A) No. H11-213402

### DISCLOSURE OF THE INVENTION

### Problem to be Solved by the Invention

In such a conventional servo adjusting method, however, the servo adjustment has to be performed in advance for all of the recording layers of an optical disk. The method has a problem such that it takes time for the servo adjustment.

An object of the present invention is to solve such a problem and to provide an information reproducing apparatus, a servo adjusting method, and the like realizing reduced time required for servo adjustment, and the like.

### Means for Solving the Problem

In order to solve the above problem, the invention according to claim 1 relates to an information reproducing apparatus for reproducing information recorded on a recording medium having a plurality of recording layers, comprising:

signal level measuring means for measuring a signal level of each of recording layers; and

servo adjusting means for performing servo adjustment on at least one of the recording layers, storing a servo adjustment value in the servo adjustment, and in the case where the recorded information is reproduced from the recording layers, performing servo adjustment on the recording layers so as to become to the servo adjustment value,

wherein when a level ratio of signal levels of at least two recording layers in the measured signal levels of the recording layers lies in a threshold range, the servo adjusting means performs the servo adjustment on one of the recording layers, stores the servo adjustment value in the servo adjustment and, in the case where the recorded information is reproduced from the other recording layer, performs the servo adjustment on the other recording layer so as to become to the servo adjustment value for one recording layer.

The invention according to claim 4 relates to an information reproducing apparatus for reproducing information recorded on a recording medium having a plurality of recording layers, comprising:

signal level measuring means for measuring a signal level of each recording layer; and

servo adjusting means for performing servo adjustment on at least one of the recording layers, storing a servo adjustment value in the servo adjustment, and in the case where the recorded information is reproduced from the recording layer, performing the servo adjustment on the recording layer so as to become to the servo adjustment value,

wherein the servo adjusting means does not perform the servo adjustment on the recording layers other than a representative recording layer and whose signal level difference from the signal level of the representative recording layer is equal to or less than a predetermined value, out of the recording layers whose signal levels were measured, and in the case where the recorded information is reproduced from the recording layers other than the representative recording layer, the servo adjusting means performs the servo adjustment on the recording layers other than the representative recording layer so as to become to the servo adjustment value for the representative recording layer.

The invention according to claim 9 relates to a servo adjusting method in an information reproducing apparatus for reproducing information recorded on a recording medium having a plurality of recording layers, comprising:

a process of measuring a signal level of each of recording layers; and

a servo adjusting process of performing servo adjustment on at least one of the recording layers, storing a servo adjustment value in the servo adjustment, and in the case where the recorded information is reproduced from the recording layers, performing servo adjustment on the recording layers so as to become to the servo adjustment value,

wherein in the servo adjusting process, in the case where a level ratio of signal levels of at least two recording layers in the measured signal levels of the recording layers lies in a threshold range, the servo adjustment on one of the recording layers is performed, the servo adjustment value in the servo adjustment is stored, and in the case where the recorded information is reproduced from the other recording layer, the servo adjustment is performed on the other recording layer so as to become to the servo adjustment value for one recording layer.

The invention according to claim 10 relates to a servo adjusting method in an information reproducing apparatus for reproducing information recorded on a recording medium having a plurality of recording layers, comprising:

a process of measuring a signal level of each recording layer; and

a servo adjusting process of performing servo adjustment on at least one of the recording layers, storing a servo adjustment value in the servo adjustment, and in the case where the recorded information is reproduced from the recording layer, performing the servo adjustment on the recording layer so as to become to the servo adjustment value,

wherein in the servo adjusting process,

the servo adjustment is not performed on the recording layers other than a representative recording layer and whose signal level difference from the signal level of the representative recording layer is equal to or less than a predetermined value, out of the recording layers whose signal levels were measured, and in the case where the recorded information is reproduced from the recording layers other than the representative recording layer, the servo adjustment is performed on the recording layers other than the representative recording layer so as to become to the servo adjustment value for the representative recording layer.

The invention according to claim 11 relates to a servo adjustment processing program for making a computer included in an information reproducing apparatus for reproducing information recorded on a recording medium having a plurality of recording layers function as:

signal level measuring means for measuring a signal level of each of recording layers; and

servo adjusting means for performing servo adjustment on at least one of the recording layers, storing a servo adjustment value in the servo adjustment, and in the case where the recorded information is reproduced from the recording layers, performing servo adjustment on the recording layers so as to become to the servo adjustment value,

wherein when a level ratio of signal levels of at least two recording layers in the measured signal levels of the recording layers lies in a threshold range, the servo adjusting means performs the servo adjustment on one of the recording layers, stores the servo adjustment value in the servo adjustment, and in the case where the recorded information is reproduced from the other recording layer, performs the servo adjustment on the other recording layer so as to become to the servo adjustment value for one recording layer.

The invention according to claim 12 relates to a servo adjustment processing program for making a computer included in an information reproducing apparatus for reproducing information recorded on a recording medium having a plurality of recording layers function as:

signal level measuring means for measuring a signal level of each of recording layers; and

servo adjusting means for performing servo adjustment on at least one of the recording layers, storing a servo adjustment value in the servo adjustment, and in the case where the recorded information is reproduced from the recording layers, performing servo adjustment on the recording layers so as to become to the servo adjustment value,

wherein the servo adjusting means does not perform the servo adjustment on the recording layers other than a representative recording layer and whose signal level difference from the signal level of the representative recording layer is equal to or less than a predetermined value, out of the recording layers whose signal levels were measured, and in the case where the recorded information is reproduced from the recording layers other than the representative recording layer, the servo adjusting means performs the servo adjustment on the recording layers other than the representative recording layer so as to become to the servo adjustment value for the representative recording layer.

The invention according to claim 13 relates to an information recording medium where the servo adjustment processing program according to claim 11 or 12 is computer-readably recorded.

### BRIEF DESCRIPTION OF THE DRAWINGS

FIG. 1 Block diagram showing an example of a schematic configuration of an optical disk reproducing apparatus as an embodiment of the present invention.

FIG. 2 Flowchart showing an example of a servo adjustment value setup process in a servo controller 5 in a first embodiment.

FIG. 3 Flowchart showing an example of a servo adjustment value setup process in the servo controller 5 in a second embodiment.

### DESCRIPTION OF REFERENCE NUMERALS

1 optical pickup
2 carriage unit
3 signal amplifier
4 signal generator
5 servo controller
6 driver
7 decoder
8 system controller

### BEST MODE FOR CARRYING OUT THE INVENTION

Best modes of the present invention will be described hereinbelow with reference to the accompanying drawings. The following embodiments relate to the case of applying the present invention to an optical disk reproducing apparatus for reproducing information recorded on an optical disk (so-called multilayer optical disk) such as a DVD having a plurality of recording layers.

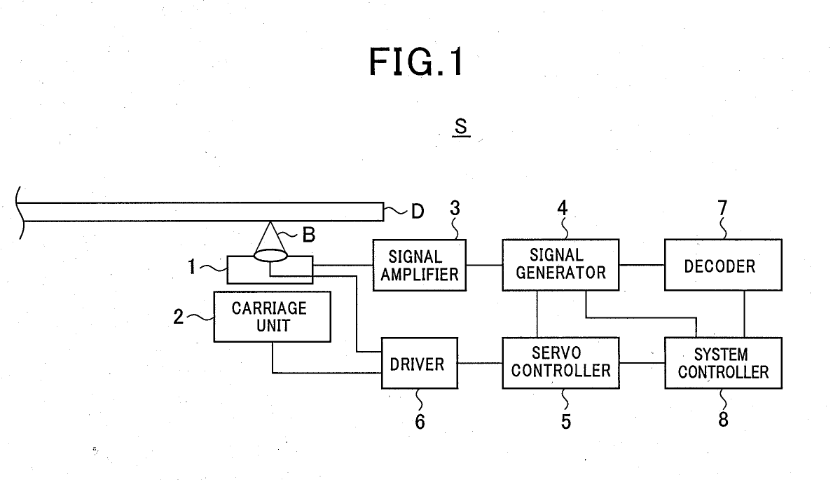

First, referring to FIG. 1, an example of a schematic configuration of an optical disk reproducing apparatus as the embodiment will be described.

FIG. 1 is a block diagram showing an example of a schematic configuration of an optical disk reproducing apparatus as the embodiment.

As shown in FIG. 1, an optical disk reproducing apparatus S includes an optical pickup 1 as an example of light receiving means and electric signal generating means, a carriage unit 2, a signal amplifier 3, a signal generator 4, a servo controller 5 as an example of signal level measuring means and servo adjusting means, a driver 6, a decoder 7, a system controller 8, and the like. A spindle motor for rotating an optical disk D mounted in a predetermined clamp position on a turn table (not shown) of the optical disk reproducing apparatus S is not shown.

The optical pickup 1 irradiates an information recording face in a predetermined recording layer (for example, a first layer) of the optical disk D with a light beam B, receives the light beam B reflected from the optical disk D, generates an electric signal (by converting the light signal to an electric signal), and outputs the electric signal to the signal amplifier 3. The optical pickup 1 has an actuator (not shown) for moving the lens of the optical pickup 1 in a focus direction (the vertical direction) and a track direction (the lateral (radial) direction) of the optical disk D in accordance with a drive signal from the driver 6.

The carriage unit 2 rotates a carriage motor (not shown) in accordance with the drive signal input from the driver 6 and moves a carriage on which the optical pickup 1 is mounted in the lateral direction along an axis.

The signal amplifier 3 amplifies the electric signal input from the optical pickup 1 and outputs the amplified signal to the signal generator 4.

The signal generator 4 generates various signals such as a focus error signal, a tracking error signal, and an RF (Radio Frequency) signal on the basis of the amplified electric signal which is input from the signal amplifier 3, outputs the focus error signal and the tracking error signal to the servo controller 5, and outputs the RF signal to the decoder 7. The tracking error signal described above is generated by a known method such as the three-beam method or the phase difference method. On the other hand, the focus error signal corresponds to a so-called S curve generated by fluctuations in the position of a track perpendicular to the information recording face or fluctuations in the position perpendicular to the focal point of the light beam B.

The servo controller 5 has not-shown elements such as a focusing servo circuit, a tracking servo circuit, a carriage servo circuit, a signal level measuring circuit, and a memory and the like, further, a controller for controlling the elements, and performs various servo controls for reproducing information recorded on the optical disk D in accordance with an instruction from the system controller 8.

Concretely, the servo controller 5 performs a phase compensating process and the like by the focusing servo circuit on the focus error signal input from the signal generator 4, generates the focusing servo control signal for eliminating an error between the focus position of the light beam B and the position in the information recording face in a direction perpendicular (perpendicular direction) to the information recording face, and outputs the signal to the driver 6. In addition, the servo controller 5 performs a phase compensating process or the like by the tracking servo circuit on the tracking error signal input from the signal generator 4, generates the tracking servo control signal for eliminating the error between the focus position of the light beam B and the position of the information recording face in the direction parallel to the information recording face, and outputs the signal to the driver 6. The servo controller 5 performs a phase compensating process or the like by the carriage servo circuit on the tracking error signal input from the signal generator 4, eliminates the error in the parallel direction which cannot be eliminated only by the movement of the lens of the optical pickup 1, generates a carriage servo control signal for moving the irradiation position of the light beam B to trace the track, and outputs the generated signal to the driver 6.

The servo controller 5 performs automatic servo adjustment (for example, adjustment by executing driving of the lens in the optical pickup 1, driving of the carriage in the carriage unit 2, focus jump, track jump, and the like) (pre-servo adjustment) on at least one recording layer (for example, the first layer) in advance (for example, when the optical disk D is loaded in the optical disk reproducing apparatus S) (that is, before start of a reproducing operation) in accordance with an instruction from the system controller 8 so that various servo controls such as a focusing servo and a tracking servo can be performed accurately. The servo controller 5 stores servo adjustment values (such as an offset amount of a tracking error signal or the like, gain, balance (symmetry of a signal level on the positive side and a signal level on the negative side when the level zero is set as the reference), and the like) in a memory. At the time of reproducing the recorded information from the recording layer, the servo controller 5 performs the servo adjustment on the recording layer with the servo adjustment values stored. As it is known, such servo adjustment is performed in a state where the focusing servo circuit and the tracking servo circuit are closed (closed state). Since the servo control and the servo adjustment are known, further detailed description will not be given.

The driver 6 amplifies the focusing servo control signal entered from the servo controller 5, generates a focusing drive signal for driving a not-shown actuator (focus actuator) in the optical pickup 1, and outputs the focusing drive signal to the optical pickup 1. By driving the focus actuator on the basis of the focusing drive signal, a focusing servo control for eliminating a positional error in the vertical direction is executed.

The driver 6 amplifies the tracking servo control signal entered from the servo controller 5, generates a tracking drive signal for driving a not-shown actuator (tracking actuator) in the pickup 1, and outputs the tracking drive signal to the optical pickup 1. By driving the tracking actuator on the basis of the tracking drive signal, a tracking servo control for eliminating a positional error in the parallel direction is executed.

The driver 6 amplifies a carriage servo control signal entered from the servo controller 5, generates a carriage drive signal for driving the carriage motor, and outputs the carriage drive signal to the carriage unit 2. The carriage motor is rotated on the basis of the carriage drive signal and, with the rotation, the shaft further rotates, thereby executing the carriage servo control for eliminating the positional error in the parallel direction and moving the irradiation position.

The decoder 7 performs an error correcting process and a decoding process on the RF signal entered from the signal generator 4 to generate a video signal, a sound signal, and the like, outputs the video signal to a display via a not-shown display processor, and outputs the sound signal to a speaker via a not-shown DAC (Digital Analog Converter) and an amplifier. The decoder 7 outputs control information obtained by the correcting process and the decoding process (for example, IDs, sub-codes, and the like designated to a plurality of data blocks constructing stored information) to the system controller 8.

The system controller 8 has a CPU (Central Processing Unit), a RAM (Random Access Memory), a ROM (Read Only Memory) for storing various data and programs, and the like. For example, when the CPU reads a program or the like stored in the ROM and executes it, the entire optical disk reproducing apparatus S is controlled in a centralized manner. For example, by giving an instruction to the servo controller 5 on the basis of an ID, a sub-code, and the like included in control information entered from the decoder 7 in accordance with an operation instruction (for example, a reproduction instruction, a chapter selection instruction, or the like) from the user entered via a not-shown operating unit, an access to the optical disk D for reproducing the recorded information is controlled.

In the configuration of the optical disk reproducing apparatus S, the servo controller 5 measures (detects) the maximum (or average) signal level (for example, the signal level (amplitude) of a tracking error signal) in the recording layers (for example, the first to third layers) by a signal level measuring circuit. In the case where the level ratio between the signal levels of at least two recording layers (for example, the first and second layers) among the signal levels of the recording layers measured lies in a threshold range (for example 0.9 to 1.1), the servo controller 5 performs automatic servo adjustment in advance only on one (for example, the first layer) of the recording layers, and stores the servo adjustment value in the adjustment. In the case where recorded information is reproduced from another recording layer (for example, the second layer), the servo controller 5 performs automatic servo adjustment on another recording layer (for example, the second layer) with the servo adjustment value used for the one recording layer (for example, the first layer). The range of the threshold is a range in which no problem occurs in reproducibility in the case where the servo adjustment value for one recording layer is applied to other recording layers. The range is examined and determined in advance.

In other words, the servo controller 5 does not perform the pre-automatic servo adjustment on a recording layer (for example, the second layer) except for the representative recording layer (for example, the first layer) and having a level difference from the signal level of the representative recording layer of a predetermined value or less among the recording layers (for example, the first to third layers) whose signal levels were measured. In the case where the recorded information is reproduced from a recording layer other than the representative recording layer, the servo controller 5 performs automatic servo adjustment on the recording layer other than the representative one with the servo adjustment value used for the representative recording layer (for example, the first layer). For a recording layer having a level different from that of the representative layer (For example, the first layer), which is not within the predetermined value, the servo adjustment is performed normally. The predetermined value is a value at which no problem occurs in reproducibility in the case where the servo adjustment value for one recording layer is applied to another recording layer. The predetermined value is examined and determined in advance.

### First Embodiment

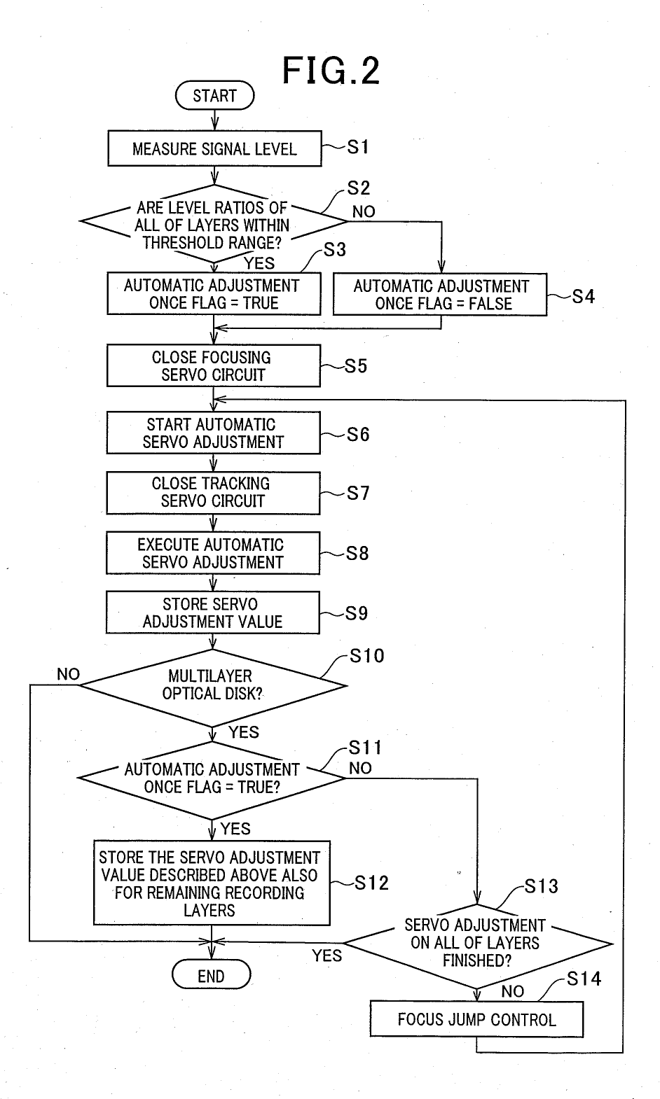

Referring now to FIG. 2, the operation of a first embodiment of the optical disk reproducing apparatus S in the case where automatic servo adjustment is performed will be described.

FIG. 2 is a flowchart showing an example of a process of setting up a servo adjustment value in the servo controller 5 in the first embodiment.

The process shown in FIG. 2 is executed when the optical disk D is loaded. When the process starts, the servo controller 5 performs a control (outputs the tracking servo control signal and the focusing servo control signal to the driver 6) to sweep the lens by a distance determined on assumption of the focal point position (focus position) of the optical disk D in the focus direction while oscillating the lens of the optical pickup 1 in the track direction (that is, making the lens meander on the track). The servo controller 5 measures, for example, the maximum signal level (for example, the signal level of the tracking error signal) of each of recording layers entered from the signal generator 4 and temporarily stores the measured level in a memory (step S1). For example, the signal level of the tracking error signal is detected at a zero cross point in the center of the so-called S-shaped characteristic of the focus error signal (which appears in each recording layer during the sweep in a state where the focus is achieved in the recording layer).

Subsequently, the servo controller 5 calculates the level ratios of all of the layers (such as the level ratio between the first and second layers, the level ratio between the second and third layers, and the level ratio between the first and third layers) and determines whether the level ratios of all of the layers lie in the threshold range (in other words, the level difference between the signal levels is within the predetermined value) or not (step S2). In the case where the level ratios of all of the layers lie in the threshold range (Yes in step S2), the servo controller 5 sets an automatic adjustment once flag to “TRUE” (step S3) and the servo controller 5 shifts to step S5. On the other hand, when the level ratios are not in the threshold range (No in step S2), the servo controller 5 sets the adjustment once flag to “FALSE” (step S4) and shifts to step S5.

In step S5, the servo controller 5 closes the focusing servo circuit. The servo controller 5 starts automatic servo adjustment on, for example, the first layer (step S6), closes the tracking servo circuit (step S7), executes the automatic servo adjustment (step S8), and stores the servo adjustment value at that time, in the example, the servo adjustment value on the first layer into an address corresponding to the first layer in the memory (step S9).

Subsequently, the servo controller 5 determines whether the optical disk D presently rotating is a multilayer optical disk or not (for example, on the basis of the waveform of the focus error signal) (step S10). In the case where it is not a multilayer optical disk (No in step S10), the setup process is finished. On the other hand, when the optical disk D is a multilayer optical disk (Yes in step S10), the servo controller 5 determines whether the automatic adjustment once flag is “TRUE” or not (step S11).

When the automatic adjustment once flag is “TRUE” (Yes in step S11), the servo controller 5 stores the servo adjustment value obtained by the automatic servo adjustment in the step S8 (in this example, the servo adjustment value for the first layer) into the addresses of the memory corresponding to the remaining layers (in this example, the second and third layers) (step S12), and finishes the setup process. That is, for example, the servo adjustment value for the first layer is stored as the servo adjustment value for the remaining layers (in this example, the second and third layers). It is also possible to store information indicative of a recording layer to be used by the second and third layers (for example, “1” indicative of the first layer) in place of storing the servo adjustment value for the first layer in the addresses in the memory corresponding to the second and third layers (in this case, upon reproduction, the servo controller 5 refers to the information, reads the servo adjustment value for the first layer to be used by a recording layer (for example, the second layer) designated by the system controller 8 from the address in the memory corresponding to the first layer, and executes the automatic servo adjustment on a recording layer to be reproduced (for example, the second layer) so that the servo adjustment value is set, the operations are similarly performed also in the second embodiment).

On the other hand, when the automatic adjustment once flag is not “TRUE” (it is “FALSE) (No in step S11), the automatic servo adjustment is performed on the recording layers as usual. First, the servo controller 5 determines whether the automatic servo adjustment has been finished on all of the layers or not (step S13). In the case where the automatic servo adjustment has not been finished on all of the layers (No in step S13), the servo controller 5 executes a control of a focus jump to the next recording layer (that is, moves the lens of the optical pickup 1 from the recording layer (for example, the first layer) on which the automatic servo adjustment is performed just before to the next recording layer (for example, the second layer) (step S14), and returns to the step S6. In such a manner, the processes in the steps S7 to S9 are executed also on recording layers after the focus jump. When the automatic servo adjustment has been finished on all of the layers (Yes in step S13), the setup process is finished.

After completion of the setup process, when the system controller 8 starts reproducing operation in accordance with an operation instruction (for example, a reproduction instruction, a chapter selection instruction, or the like) from a user entered via a not-shown operation unit, a reproduction instruction including designation of a recording layer to be reproduced (for example, the second layer) and the track position is given to the servo controller 5. In response to the instruction, the servo controller 5 reads the servo adjustment value stored in the address in the memory, corresponding to the recording layer (for example, the second layer) designated by the system controller 8, and performs the automatic servo adjustment on the recording layer to be reproduced (for example, the second layer) so that the servo adjustment value of the recording layer to be reproduced becomes the read servo adjustment value. That is, in the case where the automatic adjustment once flag is “TRUE” in the step S9 and, for example, the servo adjustment value of the first layer is stored in the address corresponding to the second layer and the recorded information is reproduced from the second layer, the automatic servo adjustment on the second layer is performed with the servo adjustment value used for the first layer.

As described above, in the first embodiment, the servo controller 5 measures the signal levels of the recording layers. In the case where the level ratios of the signal levels of all of the layers lie in the threshold range, the servo controller 5 performs the pre-automatic servo adjustment only on one recording layer (for example, the first layer) of the recording layers and stores the servo adjustment value in the servo adjustment. In the case where recorded information is reproduced from another recording layer (for example, the second layer), the automatic servo adjustment is performed on the another recording layer (for example, the second layer) with the servo adjustment value used for the one recording layer (for example, the first layer). Consequently, it is sufficient to perform the automatic servo adjustment on only one of the plurality of recording layers. It is therefore unnecessary to close the tracking servo circuit and perform the pre-automatic servo adjustment on all of the recording layers. Thus, time required for the automatic servo adjustment can be reduced.

In other words, the servo controller 5 does not perform the pre-automatic servo adjustment on the recording layer (for example, the second layer) except for the representative recording layer (for example, the first layer), whose level difference from the signal level of the representative recording layer is within a predetermined value, out of the recording layers whose signal levels were measured. In the case where recorded information is reproduced from the recording layer other than the representative layer, the automatic servo adjustment is performed on the recording layers other than the representative recording layer with the servo adjustment values used for the representative recording layer (for example, the first layer). It is therefore unnecessary to close the tracking servo circuit and perform the pre-automatic servo adjustment on the recording layers other than the representative recording layer. Thus, time required for the automatic servo adjustment can be reduced.

In the first embodiment, in the case where the level ratios of all of layers lie in the threshold range (Yes in step S2), the automatic adjustment once flag is set to “TRUE”. In the case where the level ratios are out of the threshold range (No in step S2), the automatic adjustment once flag is set to “FALSE”. In the case where the level ratios of the signal levels of at least two recording layers out of all of the recording layers lie in the threshold range, the automatic adjustment once flag may be set to “TRUE” for the combination.

When it is assumed that there are three recording layers, the level ratio of the signal levels of the first and second layers lies in the threshold range, and the level ratio of the signal levels of the first and third layers does not lie in the threshold range, the automatic adjustment once flag for the combination of the first and second layers is set to “TRUE”. With respect to the combination with the automatic adjustment once flag of “TRUE”, the automatic servo adjustment is performed only for any one (for example, the first layer) of the recording layers. The servo adjustment value at that time is applied to all of recording layers related to the combination of the automatic adjustment once flag “TRUE” (for example, the same servo adjustment value is stored in the addresses in the memory, corresponding to the first and second layers and used for servo adjustment before reproduction of the recorded information from the first or second layer). On the other hand, the automatic servo adjustment is performed for a recording layer (for example, the third layer) which does not belong to the combination, and the servo adjustment value at that time is applied to the recording layer (for example, the third layer). With the configuration, even when a number of recording layers in the optical disk D becomes three or more, the time required for the automatic servo adjustment can be reduced, and more accurate servo adjustment can be performed.

For example, when there are four recording layers, there may be a case that there a plurality of combinations of the recording layers in which the level ratios of the signal levels lie in the threshold range like the case where the level ratio of the signal levels of the first and second layers lies in the threshold range and the level ratio of the signal levels of the third and fourth layers lies in the threshold range. In the case where the automatic adjustment once flag is set to “TRUE” for the combination of the first and second layers, the automatic adjustment once flag is set to “TRUE” for the combination of the third and fourth layers, the pre-servo adjustment is performed on one recording layer for each of the combinations (in other words, each of a plurality of representative recording layers (for example, the first and third layers) whose level difference of the signal levels is equal to or larger than the predetermined value is stored (for example, the same servo adjustment value is stored in the addresses in the memory, corresponding to the first and second layers, and the same servo adjustment value is stored in the addresses in the memory, corresponding to the third and fourth layers), and recording information is reproduced from a certain recording layer, the servo adjustment is performed on the recording layer with the servo adjustment value used for the combination belonging to the recording layer. In other words, in the case where recorded information is reproduced from a recording layer (second layer) other than the representative layer, the servo adjustment is performed on the recording layer other than the representative recording layer with the servo adjustment value used for the representative recording layer (for example, the first layer) whose signal level is the closest among the servo adjustment values for the plurality of representative recording layers. With such a configuration, even when the number of recording layers of the optical disk D becomes four or more, time required for the automatic servo adjustment can be reduced, and more accurate servo adjustment can be performed.

Further, in the case where the level ratio of the signal levels of a plurality of recording layers lies in the threshold range, the pre-automatic servo adjustment is performed on one representative recording layer. When the level ratio of the signal levels of at least three recording layers lies in the threshold range (also in the case where three recording layers belong to the combination of the one recording layer), one recording layer having the most average (typical) signal level among the recording layers is set as a representative recording layer (that is, when one representative recording layer and a plurality of recording layers other than the representative layer closest to the signal level of the one representative recording layer are grouped, the signal level of the representative recording layer is the most average signal level among the signal levels of the recording layers in the group), the servo adjustment is performed on the recording layer, and the servo adjustment value in the servo adjustment may be stored. For example, when it is assumed that the signal level of the first layer is “8”, the signal level of the second layer is “10”, and the signal level of the third layer is “9”, the average signal level is “9”. Therefore, the third layer having the signal level corresponds to the representative recording layer. With such a configuration, the servo adjustment value of one recording layer having the average (typical) signal level is applied also to the other recording layers. Thus, the time required for the automatic servo adjustment can be reduced, and more accurate servo adjustment can be performed.

### Second Embodiment

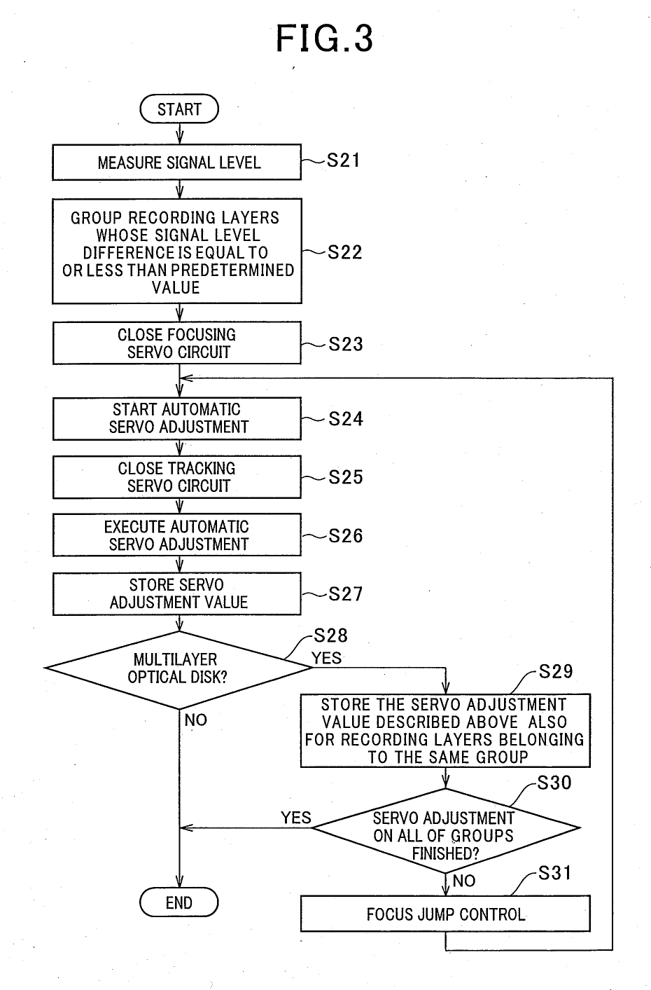

With reference to FIG. 3, the operation of a second embodiment of the optical disk reproducing apparatus S in the case where the automatic servo adjustment is performed will be described.

FIG. 3 is a flowchart showing an example of the process of setting up the servo adjustment value in the servo controller 5 in the second embodiment.

The second embodiment relates to an example of the process of setting up the servo adjustment value in the case where the representative recording layer and the recording layer whose level difference from the signal level of the representative recording layer is within the predetermined value are regarded as one group.

The process shown in FIG. 3 is executed when the optical disk D is loaded in a manner similar to the process shown in FIG. 2. When the process starts, like the step S1 in FIG. 2, the servo controller 5 performs a control so as to sweep the lens by a distance determined on assumption of the focal point position of the optical disk D in the focus direction while oscillating the lens of the optical pickup 1 in the track direction. The servo controller 5 measures, for example, the maximum signal level of each of recording layers entered from the signal generator 4 and temporarily stores the measured level in a memory (step S21).

Subsequently, the servo controller 5 compares the measured levels of the recording layers with each other, groups the recording layers whose signal levels have the level difference which is within the predetermined value (for example, the level difference is small) (in other words, the recording layers whose level difference is larger than the predetermined value are formed in another group) (step S22), associates group information indicative of group names with information indicative of the recording layers, and stores the resultant information into the memory. For example, the group of the first and second layers in which the level difference of the signal levels is within a predetermined value (in other words, the level ratio of the signal levels is within the threshold range) is set as the group 1, and the group information indicative of the group 1 is given to information indicative of the first and second layers. On the other hand, the group of the third and fourth layers having the level difference of the signal levels is within the predetermined value is set as the group 2. The group information indicative of the group 2 is given to information indicative of the third and fourth layers.

Subsequently, the servo controller 5 closes the focusing servo circuit (step S23) and starts automatic servo adjustment on the first layer (representative recording layer) belonging to the group 1 (step S24). In a manner similar to the steps S6 to S9 shown in FIG. 2, processes in steps S25 to S27 are performed (repetitive description will not be given). Subsequently, the servo controller 5 determines whether the optical disk D presently rotating is a multilayer optical disk or not (step S28). In the case where it is not a multilayer optical disk (No in step S28), the setup process is finished. On the other hand, when the optical disk D is a multilayer optical disk (Yes in step S28), the servo controller 5 stores the servo adjustment value obtained by the automatic servo adjustment in the step S26 (for example, the servo adjustment value on the first layer belonging to the group 1) into the address in the memory, corresponding to the recording layer belonging to the same group indicated by the same group information (for example, the second layer belonging to the group 1) (step S29).

After that, the servo controller 5 determines whether the automatic servo adjustment on all of the groups has been finished or not (step S30). In the case where the automatic servo adjustment on all of the groups has not been finished yet (No in step S30), the servo controller 5 executes a control of a focus jump to the representative recording layer (for example, the third layer) belonging to the group (for example, the group 2) on which the automatic servo adjustment has not been performed (step S31) and returns to the step S24. In such a manner, the processes in the steps S25 to S27 are executed also on recording layers after the focus jump. The servo adjustment value obtained by the automatic servo adjustment in (just before) the step S26 (for example, the servo adjustment value on the third layer belonging to the group 2) is stored in the address in the memory corresponding to the recording layer belonging to the same group indicated by the same group information (for example, the fourth layer belonging to the group 2) (step S29). In the case where the automatic servo adjustment on all of the groups has been finished (Yes in step S30), the setup process is finished.

After completion of the setup process, in a manner similar to the first embodiment, when the system controller 8 starts reproducing operation, the servo controller 5 reads the servo adjustment value stored in the address in the memory, corresponding to the recording layer (for example, the second layer) designated by the system controller 8, and performs the automatic servo adjustment on the recording layer to be reproduced (for example, the second layer) so that the servo adjustment value of the recording layer to be reproduced becomes the servo adjustment value.

As described above, in the second embodiment, the servo controller 5 measures the signal levels of the recording layers, and groups the recording layers whose signal level differences are equal to or less than a predetermined value or those signal level ratios lie in a threshold range. The servo controller 5 performs the servo adjustment on representative recording layers in groups, and stores the servo adjustment values at that time. In the case where recorded information is reproduced from a recording layer other than the representative recording layer in a certain group, the servo adjustment is performed on the recording layers other than the representative recording layer with the servo adjustment values used for the representative recording layer belonging to the groups. Thus the time required for the automatic servo adjustment can be reduced and more accurate servo adjustment can be performed in each group.

In a manner similar to the first embodiment, in the case where at least three recording layers belong to a single group, it is also possible to use a recording layer having the most average (typical) signal level in the recording layers as a representative recording layer, perform servo adjustment o the recording layer, and store a servo adjustment value in the servo adjustment.

Although the example where the function of the signal level measuring means of the present invention is performed by the servo controller 5 has been described in the foregoing embodiment, the invention is not limited to the embodiment. The function may be performed by the system controller 8.

In the foregoing embodiment, all or part of the servo controller 5 may be constructed by hardware or software and it is not limited. In the case where the servo controller 5 is constructed by software, the servo controller 5 is provided with a computer such as a DSP. By the servo adjustment processing program of the invention, the computer functions to measure the signal level of each of recording layers, perform servo adjustment on at least one recording layer, store a servo adjustment value in the servo adjustment and, in the case where recorded information is reproduced from the recording layer, perform servo adjustment on the recording layer using the servo adjustment value. Further, in the case where the level ratio of signal levels of at least two recording layers out of the measured signal levels of the recording layers lies in a threshold range, the computer functions to perform servo adjustment on one of the recording layers, store a servo adjustment value in the servo adjustment and, in the case where recorded information is reproduced from another recording layer, perform servo adjustment on the other recording layer using the servo adjustment value for the one recording layer. In other words, by the servo adjustment processing program, the computer does not perform the servo adjustment on the recording layers other than a representative layer and whose signal level difference from the signal level of the representative recording layer is equal to or less than a predetermined value, out of the recording layers whose signal levels were measured and, in the case where the recorded information is reproduced from the recording layers other than the representative recording layer, the computer performs the servo adjustment on the recording layers other than the representative recording layer using the servo adjustment value for the representative recording layer.

The servo adjustment processing program may be pre-stored in the ROM or the like in the optical disk reproducing apparatus S. The program may be stored in a predetermined server connected to the Internet or the like, downloaded from the server to the optical disk reproducing apparatus S, and stored in, for example, a nonvolatile memory or an HD. Alternately, the program may be read from a recording medium such as a CD-ROM via a drive or the like into the optical disk reproducing apparatus S and stored in a nonvolatile memory or an HD.

All of the disclosures of the Japanese Patent Application (No. 2006-5666) including the specification, the claims, the drawings, and the abstract filed on Jan. 13, 2006 are incorporated herein by reference.

1-13. (canceled)

14. An information reproducing apparatus for reproducing information recorded on a recording medium having a plurality of recording layers, comprising:
a signal level measuring device which measures a signal level of each of recording layers; and
a servo adjusting device which performs servo adjustment on at least one of the recording layers, stores a servo adjustment value in the servo adjustment, and in the case where the recorded information is reproduced from the recording layers, performs servo adjustment on the recording layers so as to become to the servo adjustment value,
wherein when a level ratio of signal levels of at least two recording layers in the measured signal levels of the recording layers lies in a threshold range, the servo adjusting device performs the servo adjustment on one of the recording layers, stores the servo adjustment value in the servo adjustment and, in the case where the recorded information is reproduced from the other recording layer, performs the servo adjustment on the other recording layer so as to become to the servo adjustment value for one recording layer.

15. The information reproducing apparatus according to claim 14,
wherein there are a plurality of combinations of recording layers, in each of which a level ratio of the signal levels lies in a threshold range,
wherein there are a plurality of combinations of recording layers, in each of which a level ratio of the signal levels lies in a threshold range,
the servo adjusting device performs servo adjustment on one of the recording layers in each of the combinations, stores a servo adjustment value in the servo adjustment and, in the case where the recorded information is reproduced from the recording layer, performs the servo adjustment on the recording layer so as to become to one servo adjustment value for the combination to which the recording layer belongs.

16. The information reproducing apparatus according to claim 14,
wherein in the case where the level ratio of signal levels of at least three recording layers lies in a threshold range, servo adjustment is performed on one of the recording layers, having the most average signal level among the recording layers, and a servo adjustment value in the servo adjustment is stored.

17. An information reproducing apparatus for reproducing information recorded on a recording medium having a plurality of recording layers, comprising:
a signal level measuring device which measures a signal level of each recording layer; and
a servo adjusting device which performs servo adjustment on at least one of the recording layers, stores a servo adjustment value in the servo adjustment, and in the case where the recorded information is reproduced from the recording layer, performs the servo adjustment on the recording layer so as to become to the servo adjustment value,
wherein the servo adjusting device does not perform the servo adjustment on the recording layers other than a representative recording layer and whose signal level difference from the signal level of the representative recording layer is equal to or less than a predetermined value, out of the recording layers whose signal levels were measured, and in the case where the recorded information is reproduced from the recording layers other than the representative recording layer, the servo adjusting device performs the servo adjustment on the recording layers other than the representative recording layer so as to become to the servo adjustment value for the representative recording layer.

18. The information reproducing apparatus according to claim 17,
wherein the servo adjusting device performs servo adjustment on each of a plurality of the representative recording layers whose signal level difference is equal to or larger than a predetermined value, stores the servo adjustment values in the servo adjustments, and in the case where the recorded information is reproduced from a recording layer other than the representative layers, performs servo adjustment on a recording layer other than the representative recording layers so as to become to the servo adjustment value for the representative recording layer having the closest signal level among the servo adjustment values for the plurality of representative recording layers.

19. The information reproducing apparatus according to claim 17,
wherein in the case where one of the representative recording layers, and a plurality of recording layers other than the representative recording layers and closest to the signal level of one representative recording layer are set as a group, the signal level of the representative recording layer is the most average signal level of the signal levels of the recording layers in the group.

20. The information reproducing apparatus according to claim 14,
wherein the servo adjusting device groups recording layers whose signal level ratio is within a threshold range or whose signal level difference is equal to or less than a predetermined value in recording layers whose signal levels were measured, performs servo adjustment on each of representative recording layers in groups, stores a servo adjustment value for each of the representative recording layers, and in the case where recorded information is reproduced from a recording layer other than the representative recording layer in a group, performs the servo adjustment on the recording layer other than the representative recording layer so as to become to the servo adjustment value for the representative recording layer belonging to the group.

21. The information reproducing apparatus according to claim 14, further comprising:
a light receiving device which irradiates the recording layer in the recording medium with light and receiving the reflected light; and
an electric signal generating device which generates an electric signal from the received light,
wherein the signal level measuring device measures a signal level of the generated electric signal.

22. A servo adjusting method in an information reproducing apparatus for reproducing information recorded on a recording medium having a plurality of recording layers, comprising:
a process of measuring a signal level of each of recording layers; and
a servo adjusting process of performing servo adjustment on at least one of the recording layers, storing a servo adjustment value in the servo adjustment, and in the case where the recorded information is reproduced from the recording layers, performing servo adjustment on the recording layers so as to become to the servo adjustment value,
wherein in the servo adjusting process, in the case where a level ratio of signal levels of at least two recording layers in the measured signal levels of the recording layers lies in a threshold range, the servo adjustment on one of the recording layers is performed, the servo adjustment value in the servo adjustment is stored, and in the case where the recorded information is reproduced from the other recording layer, the servo adjustment is performed on the other recording layer so as to become to the servo adjustment value for one recording layer.

23. A servo adjusting method in an information reproducing apparatus for reproducing information recorded on a recording medium having a plurality of recording layers, comprising:
a process of measuring a signal level of each recording layer; and
a servo adjusting process of performing servo adjustment on at least one of the recording layers, storing a servo adjustment value in the servo adjustment, and in the case where the recorded information is reproduced from the recording layer, performing the servo adjustment on the recording layer so as to become to the servo adjustment value,
wherein in the servo adjusting process,
the servo adjustment is not performed on the recording layers other than a representative recording layer and whose signal level difference from the signal level of the representative recording layer is equal to or less than a predetermined value, out of the recording layers whose signal levels were measured, and in the case where the recorded information is reproduced from the recording layers other than the representative recording layer, the servo adjustment is performed on the recording layers other than the representative recording layer so as to become to the servo adjustment value for the representative recording layer.

24. An information recording medium where a servo adjustment processing program is computer-readably recorded,
the servo adjustment processing program making a computer included in an information reproducing apparatus for reproducing information recorded on a recording medium having a plurality of recording layers function as:
a signal level measuring device which measures a signal level of each of recording layers; and
a servo adjusting device which performs servo adjustment on at least one of the recording layers, stores a servo adjustment value in the servo adjustment, and in the case where the recorded information is reproduced from the recording layers, performs servo adjustment on the recording layers so as to become to the servo adjustment value,
wherein when a level ratio of signal levels of at least two recording layers in the measured signal levels of the recording layers lies in a threshold range, the servo adjusting device performs the servo adjustment on one of the recording layers, stores the servo adjustment value in the servo adjustment, and in the case where the recorded information is reproduced from the other recording layer, performs the servo adjustment on the other recording layer so as to become to the servo adjustment value for one recording layer.

25. An information recording medium where a servo adjustment processing program is computer-readably recorded,
the servo adjustment processing program making a computer included in an information reproducing apparatus for reproducing information recorded on a recording medium having a plurality of recording layers function as:
a signal level measuring device which measures a signal level of each of recording layers; and
a servo adjusting device which performs servo adjustment on at least one of the recording layers, stores a servo adjustment value in the servo adjustment, and in the case where the recorded information is reproduced from the recording layers, performs servo adjustment on the recording layers so as to become to the servo adjustment value,
wherein the servo adjusting device does not perform the servo adjustment on the recording layers other than a representative recording layer and whose signal level difference from the signal level of the representative recording layer is equal to or less than a predetermined value, out of the recording layers whose signal levels were measured, and in the case where the recorded information is reproduced from the recording layers other than the representative recording layer, the servo adjusting device performs the servo adjustment on the recording layers other than the representative recording layer so as to become to the servo adjustment value for the representative recording layer.
